(19) United States
(12) Patent Application Publication
(10) Pub. No.: US 2003/0041142 A1
(43) Pub. Date: Feb. 27, 2003

(54) Generic network monitoring tool

(75) Inventors: Junbiao Zhang, Highland Park, NJ (US); Sumathi Gopal, North Brunswick, NJ (US)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC USA, INC.

(21) Appl. No.: 09/938,558

(22) Filed: Aug. 27, 2001

(51) Int. Cl. G06F 15/173

(52) U.S. Cl. 709/224; 709/223

(57) ABSTRACT

The present invention includes a generic monitoring system and method having a generic core that includes a logical control layer, various network adaptors at a network adaptor layer and application specific modules at a graphical interface layer. The generic core has the essential components, operational model and functionalities that are common across monitoring tools. Network adaptors glue the core to different kinds of active networks so that messages from the active networks can be translated into a format understood by the core. Application specific modules are used to customize the user interfaces and event handling functions so that the generic monitoring system and method can be tailored to individual application needs. The present invention can be applied to multiple active packet networks with minimum adaptation or modification of the generic core.

### BACKGROUND OF THE INVENTION

1. Field of the Invention

The present invention relates to a generic monitoring system and method for networks, and more specifically, a network monitoring tool having a layered architecture with a general extension framework for network and application customization.

2. Description of the Related Art

In the related art traditional network, packets include data containers carrying a fixed format payload. Further, the related art active network is a networking paradigm in which individual packets are intelligent program capsules that invoke service functions at network nodes, such that both the network and individual packets are programmable. The network becomes programmable by downloading new protocol code to the network nodes, and the individual packets become programmable by executing customizable code segments located in the packets at traversing nodes.

Accordingly, the related art active network allows for flexibility in deploying new protocols and adapting network services to specific application needs. As a result, network management, especially network monitoring, which is vital to the proper operation of communication networks, has become even more important for related art active networks. For example, in the related art active network, network monitoring tasks are easily handled by properly programming active packets to collect and analyze relevant data at network nodes. Additionally, network management functions are added to the network system by installing downloadable code.

A large number of related art network management and monitoring tools are available as either commercial products or open source software. For example, related art systems such as HP Open View (http://www.openview.hp.com) and Sun Microsystems Solstice (http://www.sun.com/solstice/) are based on a related art network monitoring platform (NMP). NMP is a suite of network monitoring software that provides an exhaustive set of non-customizable monitoring functionalities. For example, HP Open View contains tools for application management, availability management, network management, service management and storage/data management, and allows users (via the applications) to create individual views to reflect specific business information needs.

However, the related art network monitoring applications have various problems and disadvantages. For example, but not by way of limitation, the monitoring functionalities of at least the aforementioned related art systems are themselves not customizable. Thus, monitoring for new types of networks or network applications requires new monitoring tools or significant modifications to the code.

There are many related art monitoring tools that are not integrated with NMP. For example, but not by way of limitation, the InMon Traffic Server (http://www.inmon.com/products.htm) provides traffic flow monitoring for high-speed switches and produces real-time top flow charts and site-wide application-level traffic matrices. Also, the public domain software MTR (http://www.bitwizard.nl/mtr) integrates “ping” with “traceroute” to provide topology visualization and diagnostic information.

However, the related art monitoring devices also have various problems and disadvantages. For example, but not by way of limitation, the related art tools are built for monitoring specific network systems and are not customizable. Thus, most of those related art network monitoring tools only provide a few, limited functions implemented in an ad hoc manner. Thus, the related art systems lack a customizable, flexible and integrated network management system and method.

Additionally, related art common logical components exhibit different characteristics depending on the specific application context. For example, in the related art, network nodes are classified into routers and end hosts. However, related art applications may further differentiate between server nodes and client nodes, and it is very difficult for the related art system to accommodate such an additional requirement.

### SUMMARY OF THE INVENTION

It is an object of the present invention to overcome the problems and disadvantages of the related art.

It is another object of the present invention to provide a logical network layer to integrate the whole system to provide customizable yet cohesive monitoring functionality for active as well as non-active networks, including traditional networks.

It is yet another object of the present invention to provide a flexible monitoring system having generic functions for most monitoring, and a system that is capable of creating customized functions for application-specific, network monitoring requirements.

To achieve at least the aforementioned objectives a system for monitoring a network is provided, comprising a graphical interface layer that displays a logical view of said system and handles user interactions, a logical network layer that logically represents said network and integrates a customizable application module via a generic platform, and a network adaptor layer that generates management messages for said network and translates messages from said network for said logical network layer, wherein said logical network layer is positioned between said network adaptor layer and said graphical interface layer.

Further a method of monitoring a network is provided, comprising (a) receiving a message from the network, (b) handling said message through a logical network layer, (c) notifying a graphical interface layer of said handling of said message, and (d) performing a graphical operation in said graphical interface layer in accordance with said notifying step.

Also, a method of monitoring a network is provided, comprising (a) generating a request in a graphical interface layer, (b) determining whether an operation to satisfy said request can be performed at said graphical interface layer, and (c) performing said operation in one of (i) only said graphical interface layer, and (ii) said graphical interface layer and a plurality of underlying layers, based on a result of said determining step.

### BRIEF DESCRIPTION OF THE DRAWINGS

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a system architecture according to a preferred embodiment of the present invention;

FIG. 2 illustrates a system of processing messages from a network according to the preferred embodiment of the present invention;

FIG. 3 illustrates an exemplary XML customization file according to the preferred embodiment of the present invention;

FIG. 4 illustrates an output at a user interface in a graphical interface layer according to the preferred embodiment of the present invention;

FIGS. 5(a) and 5(b) illustrate methods of network management for messages in the upward and downward directions, respectively, according to the preferred embodiment of the present invention; and

FIG. 6 illustrates a method of creating a logical component according to a preferred method of the present invention.

### DETAILED DESCRIPTION OF THE INVENTION

Reference will now be made in detail to the preferred embodiment of the present invention, examples of which are illustrated in the accompanying drawings. In the present invention, the terms are meant to have the definition provided in the specification, and are otherwise not limited by the specification.

The preferred embodiment of the present invention includes a generic monitoring tool that requires minimum adaptation and is applicable to different types of networks, including, but not limited to, active networks. Despite the functional and operational differences among different active networks, a substantial number of the monitoring requirements are substantially similar. The present invention takes advantage of that substantial similarity to manage the distinctive monitoring functions of different networks by properly constructing active packets and analyzing return results at a monitoring agent.

The present invention includes an architecture that enables monitoring to be generic across many network types, including, but not limited to, active networks and traditional IP networks. The present invention provides additional flexibility in adapting and extending monitoring activities, and can be customized to suit the needs of a vast variety of networks and applications, as demonstrated by the experimental results disclosed in greater detail below. While the preferred embodiment of the present invention primarily illustrates application of an active network, the present invention can also be applied to other types of networks (i.e., traditional network with a SNMP management interface).

The preferred embodiment of the present invention includes three basic entities. First, a real network with real network nodes is the underlying network. Second, a monitoring tool communicates with the real network via the network adaptors. Third, applications that monitor the network can communicate with the monitoring tool via XML files. The XML files are the “glue” between the applications and the monitoring tool.

The generic monitoring tool provides common monitoring functionalities and user control mechanisms with a flexible and extensible framework to accommodate distinctive network and user requirements. The preferred embodiment of the present invention includes a generic core, various network adaptors and application specific modules. The generic core has the essential components, operational model and functionalities that are common across all monitoring applications. The network adaptors glue the core to different types of underlying networks so that messages from the active networks can be translated into a format that the core can read, such that commands from the core can be properly transformed into network specific active packets.

Further, the present invention uses application modules to customize user interfaces and event handling functions so that the generic monitoring tool can be customized to various application needs. An event registering and dispatching model is employed in the core of the generic monitoring tool to enable the network adaptors and application modules to interact conveniently with the core and with one other.

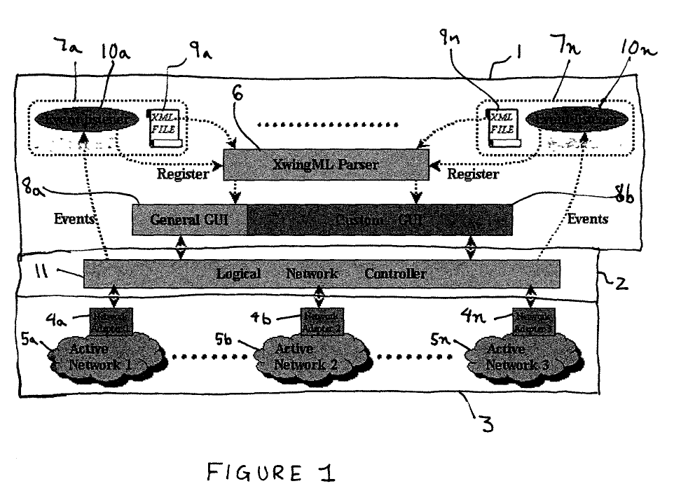

FIG. 1 illustrates a structure according to the preferred embodiment of the present invention. A graphical interface layer 1, a logical network layer 2 and a network adaptor layer 3 are provided.

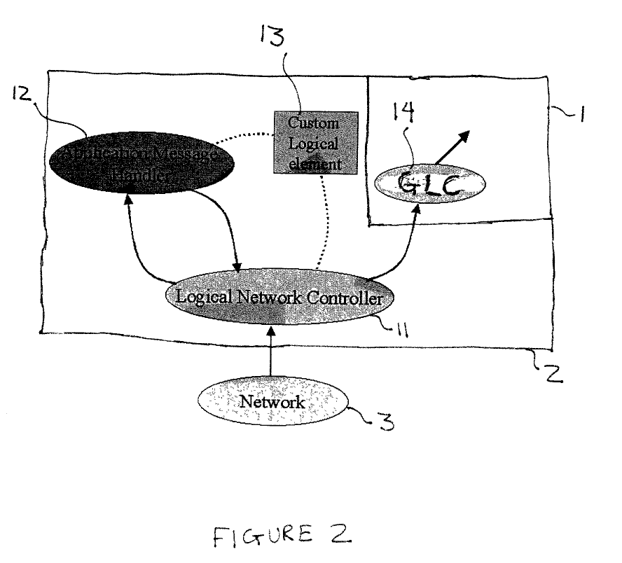

The logical network layer 2 is positioned in the center of the system, and represents the logical abstraction of the underlying active network that is being monitored. The logical abstraction includes, but is not limited to, the topology structure of the network and the logical components (e.g. nodes, links, packets) represented within the network, as well as the interactions among those components. The logical network layer 2 also embodies the essential event handling model of the monitoring tool that seamlessly integrates the network adaptor layer (i.e., lower layer) 3 and the graphical interface layer (i.e., upper layer) 1, which is discussed in greater detail with respect to FIG. 2.

The network adaptor layer 3 emulates the underlying network for the monitoring tool, such that the remaining parts of the monitoring tool need not process the network layer-specific information.

The network adaptor layer 3 includes a plurality of network adaptors 4a . . . 4n that properly encapsulate monitoring requests from upper layers (i.e., logical network layer 2 and graphical interface layer 1) into programs that can be executed in a corresponding plurality of underlying active networks 5a . . . 5n in the downward direction to the underlying network. In the upward direction, messages from the underlying active networks 5a . . . 5n are translated into a format that can be understood by the logical network layer 2. The upward and downward direction tasks can be customized through active code templates and command parameters in the network adaptors 4a . . . 4n for the active networks 5a . . . 5n. While the preferred embodiment of the present invention primarily uses active networks 5a . . . 5n, networks other than active networks (e.g., traditional networks) may also be used in alternative embodiments of the present invention.

The graphical interface layer 1 visually displays the logical view of the monitored system and handles user interactions for a plurality of applications 7a . . . 7n that include XML files 9a . . . 9n and event listeners 10a . . . 10n. The XML files 9a . . . 9n are used as initialization files that specify various user interface components, including, but not limited to, user interface layout, message handlers of the applications 7a . . . 7n and the behavior of each logical component.

The event listeners 10a . . . 10n handle events initiated by a user in the GUI (i.e., downward direction messaging). The event listeners 10a . . . 10n can be the graphical interface layer controller 1 or a graphical component. Because each application 7a . . . 7n is registered with the logical network layer 2, the logical network layer 2 can monitor and dispatch via an event message table, as described in greater detail below.

Graphical components register with their counterparts in the logical network layer 2 to properly update the graphical interface layer 1 in response to changes in the underlying network. The graphical interface layer 1 is also customizable through the use of the XML files 9a . . . 9n. For example, but not by way of limitation, customization can be achieved through an initialization file specified in XwingML, an XML application developed by Bluestone software (http://www.bluestone.com).

Applications can customize the appearance and the operation of the preferred embodiment of the present invention through the use of XwingML, which enables users to build a complete Java-Swing GUI that can be modified simply by changing the XML document. The XML document conforms to a particular Document Type Definition (DTD) specifically designed for the present invention, and builds upon the DTD of XwingML. An XwingML parser 6 is also modified to properly process specifications related to the present invention that are located in the XML document 9a . . . 9n.

Graphical interface layouts and event handling models are defined in an XML-compatible specification language and parsed by a processing engine that includes the XML parser 6. The XML parser 6 includes commercially available software that allows the logical network layer 2 to read what is presented in the graphical interface layer 1, and more specifically, in the XML files 9a . . . 9n of the applications 7a . . . 7n. Further, the XML document can be parsed using existing software, and XML can be used to describe the user interface components, event model, and application modules for the customization of the monitoring tool. The resulting graphical interface layer 1 (including event handling modules 7a . . . 7n) is glued together with the logical network layer 2 and the network adaptor layer 3 to become a fully functional monitoring tool.

The graphical interface layer 1 includes a general GUI (graphical user interface) 8a and a custom GUI 8b. The general GUI 8a includes default components that function as common libraries and can be used by any application. For example, but not by way of limitation, the default components can be used as plug-ins for a common set of features (e.g., topology, common attributes), such that the present invention is flexible. The custom GUI 8b builds custom libraries for applications that are not served by the general GUI 8a, such that the present invention provides a customizable solution. The present invention differs from the related art system in that it is highly customizable, such that a new user interface can be built as specified by the application and be managed by the graphical layer controller 14. Accordingly, new network library tools are developed much more easily.

At the core of the monitoring tool, the logical network layer 2 provides a logical representation of the underlying network and a generic platform for integrating customizable application modules. The logical network layer 2 includes a collection of logical representations for the different network entities, and a logical network controller 11 that serves as the controller and the hub of the logical network layer 2.

The corresponding logical representations in the logical network layer 2 are needed because the logical network layer 2 is a reflection of the underlying network (e.g., active network). The corresponding logical representations, referred to hereinafter as “logical components,” include, but are not-limited to:

nodes, which represent various network nodes such as routers and end hosts;

links, which represent the physical or virtual links among the network ports;

ports, which represent the network interfaces of the nodes; and

packets, which represent the data packets exchanged among network nodes.

Most of the logical components have corresponding counterparts in the graphical interface layer 1. Depending on the particular application configuration, individual elements (e.g., ports) may not be displayed in the graphical interface layer 1.

To handle the various applications 7a . . . 7n, the generic monitoring tool according to the preferred embodiment of the present invention provides a default representation for the common logical components, referred to as “basic components”. Specific applications can further customize the basic node with additional functionalities and different behaviors using inheritance or prototyping. Basic components (e.g., basic nodes and basic links) are structurally similar and include the following common elements:

a handle to the corresponding graphical component;

a handle to the logical network controller 11;

a flag indicating the status of the logical component (e.g. up/down/congested);

various gauge parameters that record statistics related to particular components (e.g. load, packet count etc.);

an event handler to process events and messages dispatched to the event handler by the logical network controller 11; and

a method for the graphical counterpart of the logical component to pass user interface events to the logical network controller 11.

The basic components have various differences. For example, but not by way of limitation, a basic port includes a handle to the basic node in which the basic port resides. Further, a basic link includes handles to the two basic ports that the basic link connects. By defining a set of basic components controlled by the logical network layer 2, required interdependencies between those elements can be specified. In particular, relations can be specified through event registration and dispatching as administered by the logical network controller 11. For example, but not by way of limitation, a basic link is notified, and the status of the basic link is properly updated when either one of the end nodes of the basic link changes status.

The logical packet abstraction represents the data exchanged among network nodes. If data abstraction was integrated into the network nodes of the aforementioned related art system, that related art system would experience various inflexibilities, especially due to the dynamic nature of packet transmission. An important feature of the monitoring tool of the present invention includes showing the traversing traces of packets. Packet abstraction results in the packet trace becoming independent of the traversed nodes. Thus, the nodes need not maintain the transient states for the packet. Instead, all messages related to the packet such as the locations and Time To Live (TTL) information are directed to the corresponding logical packet. The packet then updates itself and displays the traversing path by controlling the relevant graphical components (i.e. traversed nodes and links).

The logical network controller 11, according to the preferred embodiment of the present invention, is another part of the logical network layer 2, and controls and coordinates the logical components and drives the operation of the network monitoring system based on an event model, which is described in greater detail below.

Central to the logical network controller 11 is an event registering and dispatching engine. In this application, “Event” and “message” can be used interchangeably, since all events in the preferred embodiment of the present invention are represented as specially formatted messages. The event engine maintains a message table that maps different messages to their corresponding handlers. Each entry in the table requires a message name, and may also include the originator of the message and the name of the application. The originator of the message may include a symbol (e.g., “*”) that represents one of a plurality or originators. Further, a single message may have multiple handlers. For example, but not by way of limitation, a message from a physical node may have handlers from the corresponding logical node and logical links coupled to the physical node.

As illustrated in FIG. 2, registration with the event engine in the logical network controller 11 is handled by an application message handler 12 and/or the aforementioned logical components. In FIG. 2, the network adapter layer 3 includes the network adaptors 4a . . . 4n and the active networks 5a . . . 5n that are illustrated in FIG. 1. With respect to the application message handler 12, while the preferred embodiment of the present invention provides default logical components, each application can also include an application factory that extends and customizes the logical components, as described in greater detail below. The application created by the application factory also customizes other system actions (e.g., error handling).

During system initialization, the application message handler 12 registers messages from the network layer 3 in the logical network controller 11. The registered messages include those related to the creation of logical components. For those messages that the application does not register to handle, the logical network controller 11 handles by default.

Upon creation of the logical components, each of the logical components registers its messages with the logical network controller 11, including, but not limited to, messages that did not originate from the corresponding network component. For example, but not by way of limitation, a logical link may register handlers for all status change events related to the two end nodes it connects. When a message arrives from one of the network adaptors 4a . . . 4n, the logical network controller 11 analyzes the message and determines the message name and if present, the originator name, and the application name.

The message table is then consulted to determine which, if any, of the logical components will be notified of the message. If an originator name and/or application name is missing, the application message handler 12 or the logical network controller 11 handles the message. Then, a graphical layer controller 14 that is part of the graphical interface layer 1 and is connected to the logical network controller 11 is notified of the newly created logical component, and a graphical representation of the logical component is created as described in greater detail below.

In addition to the above-described event engine, various other functions are performed by the logical network controller 11. For example, but not by way of limitation, the logical network controller 11 contains a default logical component factory that handles unregistered component creation messages. Other unregistered generic system messages (e.g., error reports and component deletions) are also handled by the logical network controller 11. If the message cannot be processed or has been sent in error, the logical network controller 11 discards the message.

Another function performed by the logical network controller 11 is interfacing with network adaptors 4a . . . 4n. The logical network controller 11 serves as the “translator” between the network adaptors 4a . . . 4n and the other components of the system. Events generated from user interactions (e.g. checking the load of a particular node) are encapsulated into system commands, and sent to the network adaptor. Messages from one of the network adaptors (e.g., 4a) are analyzed and used to dispatch events to the correct system components.

The logical network controller 11 also maintains handles to the logical components via a table of the logical components. Even when the logical components are created by the application message handler 12, the logical network controller 11 is also notified of their creation. The table is used for system maintenance purposes (e.g., periodic status checking of the nodes).

Additionally, the logical network controller 11 initiates the creation of the graphical components. At the substantially same time as the logical network controller 11 stores a handle to a newly created logical component, the logical network controller 11 notifies the graphical interface layer 1 about the new logical component via the graphical layer controller 14 of the graphical interface layer 1, and the graphical interface layer 1 creates and displays appropriate graphical representations.

The logical network controller 11 enables generic message dispatching and handling. Thus, the system is easily extensible, applications can have their own logical representations, and new messages can easily be included in the system.

The graphical interface layer 1 assists the user in network monitoring. Although the graphical interface layer 1 provides a default representation of the network topology, the graphical user interface (GUI) is customized to suit the needs of the application or the underlying network.

Similar to the logical network layer 2, the graphical interface layer 1 comprises a controller 8a, 8b and also includes applications (e.g., nodes, links and packets) 7a . . . 7n. While not all logical components have counterparts in the graphical interface layer 1, all graphical components have counterparts in the logical network layer 2. Each graphical component is associated with a corresponding logical component for message passing and user interaction handling.

The logical component processes messages related to the network component and requests the graphical component to update the appearance of the graphical component accordingly. For example, but not by way of limitation, upon receiving a status change message, the logical component informs its graphical counterpart, then switches to a different color. When the graphical component detects a user event, such as requesting the statistics information from a node, the graphical component invokes the proper method on its logical counterpart to send the proper request into the network.

However, the graphical interface layer 1 can handle certain types of user interaction without assistance from the logical network layer 2. Examples of user interactions that can be handled by the graphical interface layer 1 include, but are not limited to, a user clicking on a node, or a user moving a node. Those types of user interactions are discussed in more detail further below with respect to FIGS. 5(a) and 5(b).

The application communicates to the generic monitoring tool of the present invention that an object needs to be displayed (i.e., network figure), or that a display needs to be changed. Thus, within the graphical interface layer 1, the application can control the look and feel of the interface, including, but not limited to, the color of the different displayed components that are handled by that application.

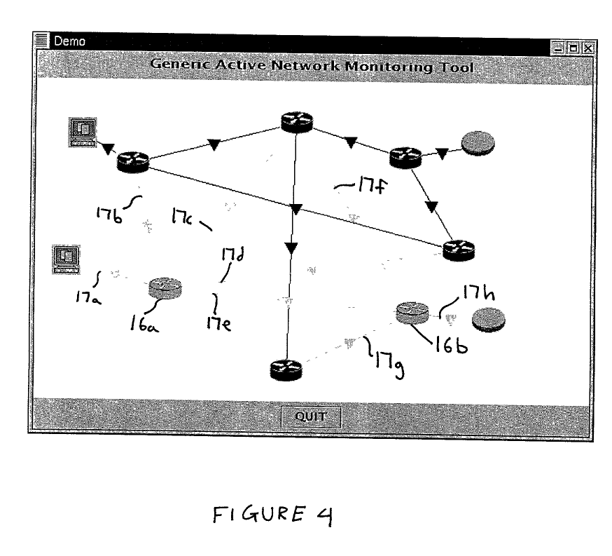

For example, but not by way of limitation, in FIG. 4, it is illustrated that the tool has been started. Further, nodes, links and the like are provided in the user interface. An XML file (e.g., 9a) allows the application to control the look and feel of the components in the user interface (e.g., node shape or link color).

As illustrated in FIG. 2, the graphical layer controller 14 is connected to the logical network controller 11 and is located in the graphical interface layer 1. The graphical layer controller 14 manages the graphical interface layer 1 and controls the creation and display of graphical components. The graphical layer controller 14 also handles user interface events not otherwise handled by any graphical components. During initialization, the graphical layer controller 14 initiates the parsing of the XML customization document by the XML parser 6 and displays the graphical interface layer 1. The XML file (e.g., 9a) also specifies the display characteristics for various types of graphical components.

The graphical layer controller 14, when notified of the creation of a new logical component by the logical network controller 11, instantiates the corresponding graphical representation as specified in the XML document. The graphical layer controller 14 also maintains a handle to the logical network controller 11 to pass down user interface events as necessary.

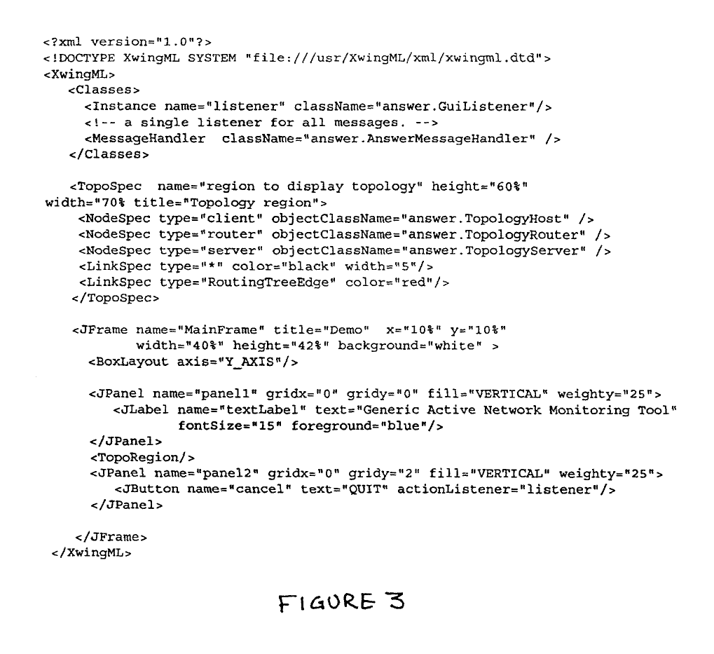

Communication between the monitoring tool of the present invention and the applications, which are independent and run on the monitoring tool, is performed via the XML file. The XML file is application-specific, such that there is one XML file per application, and as noted above, the XML file only mentions the application message handler 12. One or more application message handlers 12 may be provided for an application. Alternatively, no application message handler 12 (i.e., messages are handled in the logical network layer 2) may be provided. The application message handler 12 knows what to do when the message is received from the graphical interface layer 1. However, the monitoring tool need not handle application-specific messages. Further, the name of the application message handler 12 is provided in the XML file, as illustrated in FIGS. 3 and 4.

The names of messages that the application message handler 12 is capable of handling are registered with the logical layer (e.g., create new nodes), and the logical network layer 2 controls events. The logical network controller 11 creates a table with the names of the messages as handled by the application message handler 12. For example, but not by way of limitation, if a message is of a certain type, then it is sent to a specific application message handler 12.

As illustrated in FIG. 3, XML code is also involved in operations such as the order of displaying components in the user interface. In the preferred embodiment of the present invention, the XML language controls how the graphical interface layer 1 handles messages, as well as the general look and feel of the user interface. Further, the XML code also controls operation of user interface objects including, but not limited to, the operation of the pop-up menu.

FIG. 3 illustrates a sample XwingML configuration document according to the preferred embodiment of the present invention. The configuration document is used for the monitoring tool of the ANSWER system, which is discussed in greater detail elsewhere in this application. The document includes a listener for graphical user interface events that is specified inside the “Instance” tag. The specified Java class (“answer.GuiListener”) handles ANSWER specific user interface events and overwrites the default actions taken by the graphical layer controller 14.

The XML configuration document illustrated in FIG. 3 also includes the main message handler of the application, as specified inside the “MessageHandler” tag with the class name “answer.AnswerMessageHandler”. This is a Java class that, upon activation, registers all the message types the Java class can handle with the logical network controller 11. As also illustrated in FIG. 3, the types of graphical components in the network topology display area and their corresponding Java classes are specified within the “TopoSpec” tag. Here, three types of nodes (“client”, “router” and “server”) are defined, each having a corresponding Java class to handle its display and its interaction with users.

Additionally, the present invention includes the overall graphical user interface layout, as specified in the rest of the document within the “JFrame” tag. The “TopoRegion” tag serves as a place holder to reserve the network topology display area in the graphical user interface. All the components inside the area will be displayed according the specification in the “TopoSpec” section.

During system initialization, the graphical layer controller 14 initiates parsing of the XML document by the XwingML parser 6 in the graphical interface layer 1. As a result, the graphical layer controller 14 creates the overall graphical interface and the details of various types of graphical components. Initially, the network topology display area is empty, but is subsequently populated with actual components as the graphical layer controller 14 receives “new component” messages from the logical network controller 11.

FIG. 4 illustrates the user interface display of a monitoring interface generated from the above customization document according to the preferred embodiment of the present invention. At the time of the display, two routers 16a, 16b are down and their links 17a . . . 17h are properly updated (i.e., notified).

Since the preferred embodiment of the present invention includes a generic monitoring tool for different kinds of networks, the details of the underlying networks are shielded from the logical network layer 2 by the network adaptors 4a . . . 4n of the present invention.

The network adaptor 4a has at least two principal functions. First, when the network adaptor 4a receives a monitoring packet from an underlying active network 5a, the network adaptor 4a analyzes the packet and translates the message into a message configured by the present invention. For example, but not by way of limitation, the message must have a message name and may optionally have the application name and the originator name. Second, when the network adaptor 4a receives a request from the logical network controller 11, the network adaptor 4a converts the request in a monitoring packet and sends the request to the intended target inside the active network (e.g. a network node) 5a.

With the help of network adaptors 4a . . . 4n, the present invention can be applied to any kind of networks. For example, by using a network adaptor 4a that can understand SNMP, the network adaptor 4a of the present invention monitors networks that support the SNMP management interface (e.g., traditional networks). However, the flexible and generic nature of the present invention is best demonstrated in the case of active networks.

The distinctive characteristics of active network monitoring include (a) uniformity across the control/management planes and the data plane through the execution of active packets, which simplifies monitoring tasks and makes possible observing and interacting with the packet flows in the network, and (b) the active nature of the underlying networks, which makes monitoring tasks very flexible and extensible. In fact, the flexibility of the present invention brings benefits in both of the above-noted functions performed by the network adaptors.

Additionally, the network adaptor 4a performs the different monitoring functions requested by the logical network controller 11 by simply selecting the proper active program. Monitoring functions can be easily changed and enhanced by modifying the active packets sent from the network adaptors 4a . . . 4n. Further, the messages returned from the respective active networks 5a . . . 5n are easily adapted to a uniform format, thus greatly simplifying the processing required in the network adaptors 4a . . . 4n. The aforementioned adaptation is achieved by coding the required format directly within the active monitoring packet sent into the active networks 5a . . . 5n.

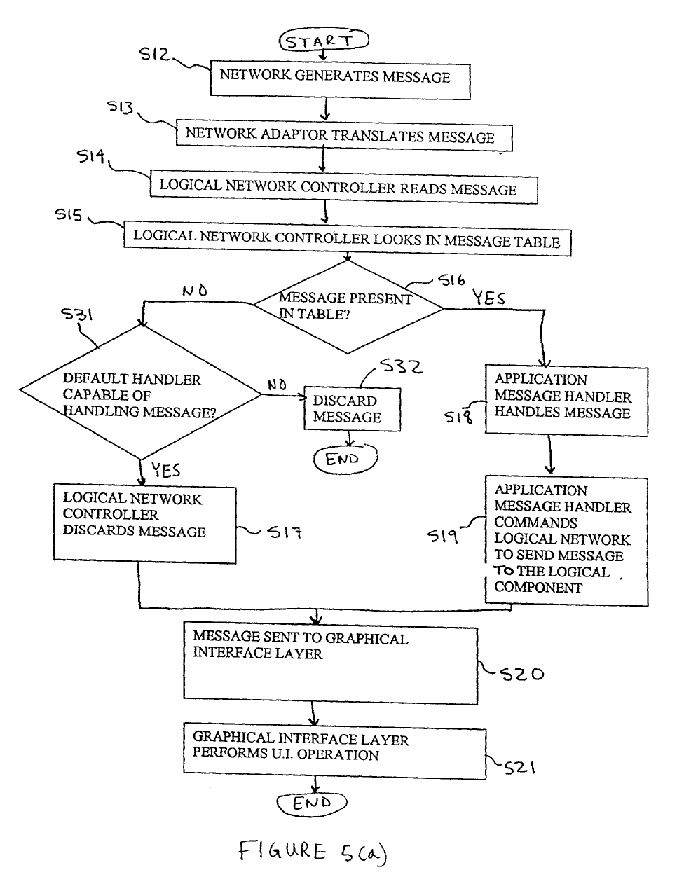

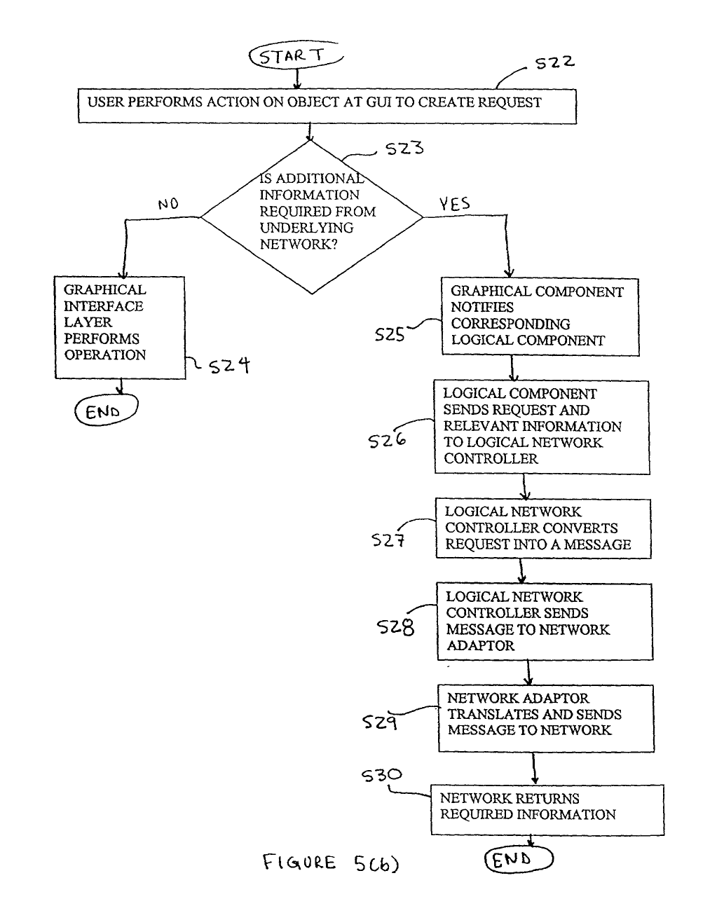

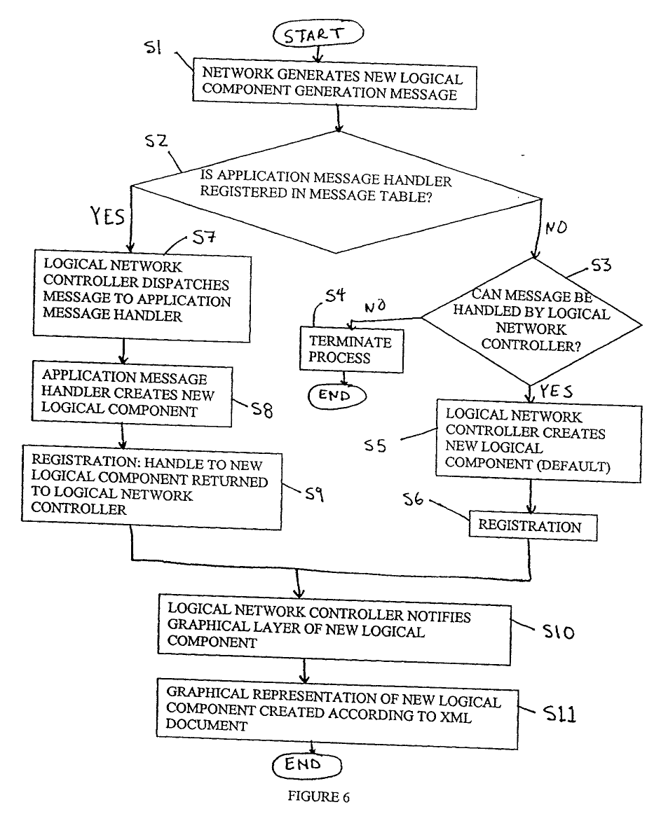

FIGS. 5(a), 5(b) and 6 illustrate preferred methods according to the present invention. FIGS. 5(a) and 5(b) illustrate downward and upward processes, respectively. It is noted that the processes illustrated in FIGS. 5(a) and 5(b), which are described in greater detail below, operate independently of one another.

FIG. 5a illustrates a method of managing a message in the upward direction according to the preferred embodiment of the present invention (i.e., a message is flowing from the network layer to the graphical interface layer). For example, but not by way of limitation, the logical network controller may create new logical components (as discussed below with respect to FIG. 6), or use the aforementioned message table to manage the already-created logical components, in the same basic method.

In a first step S12, the underlying network generates a message, which the network adaptor translates into a message that can be understood by the logical network controller in step S13. The four components of the message include, but are not limited to, name of the message, the name of the application to which the message is associated, the originator of the message, and optionally, data (e.g., for GetLoad). The data carried by the message is different for different types of messages, and the data is interpreted by the application message handler.

At step S14, the logical network controller reads the translated message, and in step S15, the logical network controller looks in a message table. At step S16, the logical network controller determines whether the message is registered (i.e., present) in the message table with an application message handler. If there is no registered application message handler, then in step S31, it is determined whether the logical network controller can handle the message. If the message cannot be handled by the logical network controller and the message does not have a registered application message handler as determined in step S16, then the message is discarded in step S32, and the process ends. If the default message handler of the logical network controller can handle the message, then at step S17, the logical network controller handles the message.

However, if there is a registered application message handler as determined in step S16, then the logical network controller dispatches the message to the proper application message handler to handle the message in step S18. At step S19, the application message handler may optionally command the logical network controller to send the message to the logical component.

Then, at step S20, the message can optionally be sent to the graphical interface layer. The graphical interface layer may then perform a user interface operation (i.e., draw a user interface object) at step S21.

FIG. 5(b) illustrates a method of managing a message in the downward direction according to the preferred embodiment of the present invention (i.e., from the graphical interface layer to the network layer). At step S22, the user performs an action on an object at the GUI of the graphical interface layer and accordingly generates a request. Then, at step S23, it is determined whether additional information is required from the underlying network.

If no additional information is required from the underlying network, and if the graphical interface layer is capable of doing so, the graphical interface layer performs the operation in accordance with the request in step S24. However, if the user selects an option that generates a request requiring information from the underlying network (e.g., GetLoad), the corresponding graphical component in the graphical interface layer notifies the corresponding logical component in the logical network layer, that is associated with the graphical component, of the request at step S25.

At step S26, the logical component sends the request to the logical network controller, along with any additional relevant information that is required for the request. In turn, the logical network controller uses the request and relevant information to convert the request into a message at step S27. The logical network controller then sends the newly converted message to the network adaptor at step S28, and the network adaptor translates and sends the message to the network at step S29. In response, the network returns the required information to the network monitoring tool at step S30, and the information is returned to the user in response to the request generated by the user action at step S22. The message table is only required during communication from the underlying network to the graphical interface layer.

In an example of the aforementioned method of communicating from the graphical interface layer to the network layer illustrated in FIG. 5(b), when a user right-clicks on the screen, the user generates a request that can be handled by the graphical interface layer. In response, a menu pops up that includes a plurality of options. The content, look and feel of the popup menu, as well as where messages from the underlying network are handled, are determined by the application. The messages may be handled in the graphical interface layer (e.g., popup menu), or alternatively, by the logical network controller if additional information is needed (e.g., GetLoad or screen refresh) and the logical network controller is capable of handling the message. In the event of an unknown message, the message is dropped by the logical network controller, and is not processed.

In the above-described example, after the user right-clicks on a node of the user interface and the popup menu is generated, the user then selects an option in the popup menu. Accordingly, if information is needed from the network, a request is sent from the graphical component to its corresponding logical component in the logical layer. In the present example, a named message can be generated by the logical network controller, which receives the request with additional relevant information from the logical component and converts the request into a message. The network adapter receives the message from the logical network controller and sends the message to the underlying network.

As an example of a message sent in the upward direction, FIG. 6 illustrates a method of creating a new logical component using the aforementioned event engine. In a first step S1, the underlying network generates a new logical component creation message (e.g., NewHost) in the format discussed above with respect to FIG. 5(a). As noted above with respect to FIGS. 5(a) and 5(b), all messages are handled in a substantially different manner, and the creation message is an exemplary illustration of a message from the underlying network. In that step S1, the network adaptor translates the creation message received from the underlying network into a format that can be understood by the logical network controller. Step S1 may be accomplished by active packets or by SNMP queries, such that non-active (i.e., traditional) packets may be used. At step S2, it is determined whether an application message handler is registered in the message table for this message/application name combination. If not, at step S3, the logical network controller determines whether the logical network controller can handle the message. If not, then the process is terminated in step S4, and the message is dropped.

However, if there is no application message handler registered for this message/application name combination as determined in step S2, and the message can be handled by the logical network controller as determined in step S4, the logical network controller performs the creation of the new logical component as a default process in step S5, and then performs registration of the new logical component in the list of logical components at step S6.

If so, the logical network controller dispatches the creation message to the message application handler at step S7, which subsequently creates a new logical component in step S8. At step S9, the new logical component is registered (i.e., added to the list of existing logical components) in the logical network controller by the application message handler.

Next, at step S10, the logical network controller notifies the graphical interface layer about the newly created logical component. At step S11, a graphical representation of the new logical component is created according to a specification in the XML document, using either default or customized graphical interface layer code. The graphical layer controller adds the graphical component to the list of graphical components that is maintained by the graphical layer controller. Thus, the graphical layer controller does not have a handle to the logical component. Using the graphical layer controller, a handle is placed from the graphical component to the logical component and vice versa. A prototype implementation of the preferred embodiment of the present invention has been completed using JDK 1.2 and XwingML 1.0. The XML parser 6 required by the XwingML processor used is the JAXP SAX parser from Sun Microsystems. Apart from the overall framework, the prototype of the present invention incorporates default message handlers for the following common messages:

New Node: When a message arrives from the network 5a indicating the addition of a new node to the network 5a, the logical network layer 2 of the present invention creates its logical and graphical representation depending on the node type. Two types of nodes are currently distinguished by present invention: Routers and hosts.

New Link: When a message arrives indicating the presence of a link between any two nodes, the preferred embodiment of the present invention creates the logical and the graphical representations for the link.

Node Status: When a message arrives indicating that a node is dead, logical network layer 2 of the present invention notifies the corresponding node and all of its links. The colors of the node and the links are changed to indicate that the node is unused. Similarly, when information arrives that a certain node has become alive again, the color of the node is changed to the normal state. The color of each link is changed depending on whether the end nodes on the two sides of the link are also alive.

Load: When a load message arrives, the present invention updates the corresponding parameters and displays them accordingly. Load may be interpreted differently on different network elements and in different applications. The present invention provides a default load representation based on the percentage of the full load.

Packet Trace: The present invention has built-in support for showing packet traces. A packet may split while traversing in the network, simulating multicasting.

An experimental version of the preferred embodiment of the present invention has been implemented for the ANSWER and JOURNEY networks. ANSWER is an active network based on an information routing system. The underlying network provides a routing backbone that directs content and query packets to their respective matching parties without explicitly specified addresses by content directory indexes, which are injected by content providers. Content directory indexes are provided in the form of ontology structures, and are propagated into the network core through periodic routing information exchanges among the ANSWER network neighbors.

To make the system scalable, a dynamic routing tree is used in the ANSWER backbone to localize content reachability information. Query packets may contain programs which makes routing decision at each node based on the index information. ANSWER was implemented using the PLAN active network package.

An exemplary initialization XwingML file related to the monitoring tool for the ANSWER system was implemented for the preferred embodiment of the present invention. As noted above, ANSWER uses specialized classes in logical and graphical interface layers to represent network components. In particular, three types of nodes are identified in the ANSWER network: hosts, routers and servers. To represent ANSWER node classification and link details (e.g. whether a link is part of the routing tree), the ANSWER application message handler overwrites the default logical network layer of the present invention's “new node” and “new link” handlers. ANSWER also introduces additional specific monitoring functions, notably “ontology tree” and “routing tree”. The “ontology tree” message represents the ontology structure on an ANSWER node and thus is only registered/handled by the corresponding node. The “routing tree” message is not targeted to any specific components and is handled by the ANSWER application message handler to correctly update the dynamic routing tree. Although the present invention logical network layer 2 does not understand the meaning of those messages, it still properly handles them, due to the above-discussed event registration and dispatching framework of the present invention.

As an additional experimental model, the preferred embodiment of the present invention was applied to the journey network. JOURNEY is an active network framework in which multicast MPEG streams are transcoded inside the network based on link conditions and end host capabilities. However, JOURNEY uses traditional IP protocol. For example, but not by way of limitation, a JOURNEY network node may automatically scale down an MPEG stream (i.e., to lower frame rate or smaller size) for a low bandwidth wireless link or a small hand-held device. A group of transcoding engines, usually computer nodes, interconnected via a high-speed local backbone, are attached to each JOURNEY node. By setting an alert option, an IP packet carrying MPEG frames is directed to one of the transcoding engines when the packet passes through a JOURNEY node. The frames are then processed and repackaged into IP packets based on the dynamic network and end host conditions. Accordingly, the JOURNEY system accommodates the different QoS requirements in different multicast paths.

The present invention was applied as the monitoring tool for the JOURNEY system to collect status information (e.g., the load on the transcoding engines), and statistical information (e.g., the number of MPEG packets processed by each JOURNEY node and the degree of transcoding along each path). In the JOURNEY dynamic system, the above-noted information is collected periodically to reflect the most up-to-date state of the JOURNEY system. To simplify the management of JOURNEY, management information bases (MIBs) that collect that information. A network adaptor with SNMP manager functions interfaces with the present invention with the JOURNEY system. Both explicit queries and trap registrations are supported by the network adaptor. Thus, the monitoring tool either actively polls the JOURNEY nodes to update monitoring information, or is notified of threshold conditions. Thus, the JOURNEY system demonstrates use of an application message handler without using the logical network controller in the present invention.

The present invention has various advantages over the related art. For example, but not by way of limitation, the preferred embodiment of the present invention has much less built-in core functionality and a more simple, generic user interface. As a result, the present invention has an extensible framework for applications to extend and customize not only the graphical interface, but also the monitoring functionalities. Thus, the present invention has at least the advantage of allowing new types of networks to be easily accommodated through new network adaptors and customized message handlers.

As an additional advantage, the preferred embodiment of the present invention has a more generic architecture and offering substantially greater flexibility in terms of functionality extension and diverse network adaptation.

The generic monitoring tool according to the preferred embodiment of the present invention includes a flexible architecture that incorporates a rich set of basic features and provides easy extension mechanisms for new features. The preferred embodiment of the present invention separates the network- and application-dependent components from the system core, which is included in the monitoring tool in the form of a layered structure.

The present invention has the advantage of allowing customization by application, which is not possible in the related art monitoring tool. For example, each application can customize based on its own requirement. Using the table, the generic monitoring tool of the present invention provides routing to the application message handler.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A system for monitoring a network, comprising:
a graphical interface layer that displays a logical view of said system and handles user interactions;
a logical network layer that logically represents said network and integrates a customizable application module via a generic platform; and
a network adaptor layer that generates management messages for said network and translates messages from said network for said logical network layer, wherein said logical network layer is positioned between said network adaptor layer and said graphical interface layer.

2. The system of claim 1, wherein said network comprises one of an active network that includes programmable packets invoking service functions at network nodes, and a traditional network.

3. The system of claim 1, wherein said logical network layer comprises:
a plurality of logical representations of entities of said network; and
a logical network controller that controls said logical network layer.

4. The system of claim 3, wherein each of said logical representations comprises one of the following logical components:
a node that represent a network node;
a port that represents a network interface of said node;
a link that represents one of a physical link and a virtual link among at least two network ports; and
a logical packet that represents a data packet.

5. The system of claim 4, wherein each of said logical representations comprises:
a handle to a corresponding graphical component in said graphical interface layer;
a handle to said logical network controller;
a flag indicative of a status of one of said logical components;
at least one gauge parameter that records statistics related to a particular said one of said logical components; and
an event handler that processes an event and a message received from said logical network controller.

6. The system of claim 5, wherein said port includes a handle to said node, and said link includes a plurality of handles to corresponding ports connected by said link.

7. The system of claim 4, wherein said logical components are interconnected by event registration and dispatching performed by said logical network controller to specify interdependencies between said logical components.

8. The system of claim 4, wherein said logical packet represents data exchanged between at least two network nodes such that a trace of said logical packet is independent of at least two nodes, and said at least two nodes do not maintain transient states for said logical packet.

9. The system of claim 8, wherein all messages for said data packet are directed to said logical packet, and said logical packet performs an updating operation and displays a traversing path by controlling particular graphical components.

10. The system of claim 3, wherein said logical network controller comprises an event registering and dispatch engine for a message, said engine comprising a message table configured to map a message to a corresponding application message handler.

11. The system of claim 10, wherein said message table comprises a message name, an originator of said message and a name of an application, wherein said originator of said message can be a symbol that represents a plurality of originators.

12. The system of claim 10, further comprising an application message handler that extends and customizes said logical representations, and registers messages to be handled with said logical network controller.

13. The system of claim 12, wherein at least one of said logical components and said application message handler register said messages to be handled with said logical network controller, such that said logical network controller controls an arriving message from said network adaptor layer via said message table.

14. The system of claim 10, wherein said logical network controller further comprises:
a default message handler that handles a message that has not been registered with said logical network controller by an application message handler; and
an interface with said network adapter layer that encapsulates and transmits events from said graphical interface layer to said network adapter layer, and analyzes and dispatches messages from said network adaptor layer to said logical components.

15. The system of claim 1, wherein said graphical interface layer comprises a graphical layer controller that manages said graphical interface layer and a plurality of graphical components.

16. The system of claim 15, wherein said graphical layer controller performs initialization to initiate parsing and display of data, presents a look and a feel of graphical components, and manages user interface events.

17. The system of claim 16, wherein all of said graphical components have corresponding logical components in said logical network layer, and an appearance of corresponding ones of said graphical components are updated in accordance with a status of said logical components in said logical network layer.

18. The system of claim 1, wherein said graphical interface layer can be customized to build a graphical user interface based on an XML document.

19. The system of claim 1, wherein said network adaptor layer comprises a network adaptor coupled between said logical network layer and an active network.

20. The system of claim 19, wherein said network adaptor analyzes a packet received from said network and translates said packet into a message that can be understood by said logical network layer in a first direction, and converts a request from said logical network layer and transmits said request to a target in said network in a second direction.

21. The system of claim 19, wherein said network adaptor performs monitoring functions requested by said logical network layer by selecting a particular active program, said monitoring functions can be customized by programming active packets sent from said network adaptor, and a required format is coded directly into said active packets to be sent to said network.

22. The system of claim 1, wherein said network adaptor layer comprises a network adaptor that supports an SNMP management interface that monitors a traditional network.

23. The system of claim 1, further comprising an application message handler that creates application-specific components, wherein said application-specific components correspond to application-specific network components.

24. The system of claim 23, wherein said application-specific components are created in accordance with an XML file specified by an application.

25. The system of claim 1, wherein said management messages comprise one of an active message for an active network and a SNMP message for a traditional network.

26. The system of claim 10, wherein said message comprises a name of said message, a name of an application to which said message is associated, an originator of said message, and data based on a type of said message.

27. A method of monitoring a network, comprising:
(a) receiving a message from the network;
(b) handling said message through a logical network layer;
(c) notifying a graphical interface layer of said handling of said message; and
(d) performing a graphical operation in said graphical interface layer in accordance with said notifying step.

28. The method of claim 27, wherein said handling step comprises
(a) comparing information from said message with data in a message table indicative of a capability of an application message handler to handle said message;
(b) processing said message based on said comparing step, in one of said application message handler and a logical network controller; and
(c) discarding said message if said message cannot be processed in said processing step.

29. The method of claim 27, said handling step comprising creating and registering a new logical component.

30. The method of claim 29, said creating and registering step comprising:
dispatching a message from a logical network controller to an application message handler;
said application message handler creating a new logical component; and
registering said new logical component in a list of existing logical components in said logical network controller.

31. The method of claim 29, said creating and registering step comprising:
creating a new logical component in said logical network layer, wherein said logical network controller performs said creating step; and
registering said new logical component in a list of existing logical components in said logical network controller.

32. The method of claim 27, further comprising:
translating said message from said network in a network adaptor into a format that is understood by said logical network layer; and
transmitting said understood message to a logical network controller in said logical network layer.

33. The method of claim 32, further comprising generating an output in said graphical interface layer in accordance with said understood message in said logical network controller, wherein said output is generated in accordance with instructions from said logical network controller.

34. The method of claim 27, wherein an initialization file describes components of a user interface, event models and application modules so as to perform customization of a monitoring tool of said network.

35.A method of monitoring a network, comprising:
(a) generating a request in a graphical interface layer;
(b) determining whether an operation to satisfy said request can be performed at said graphical interface layer; and
(c) performing said operation in one of (i) only said graphical interface layer, and (ii) said graphical interface layer and a plurality of underlying layers, based on a result of said determining step.

36. The method of claim 35, said performing step comprising:
(a) said graphical interface layer transmitting said request to a logical network controller;
(b) said logical network controller converting said request into a message and transmitting said message to a network adaptor;
(c) said network adaptor translating said message into a format readable by said network and transmitting said translated message to said network; and
(d) said network adaptor receiving information from said network in accordance with said request.

37. The method of claim 35, further comprising a graphical component in said graphical interface layer notifying a corresponding logical component in a logical network layer of said request and transmitting said request to said logical network controller.

38. The method of claim 35, wherein said request is generated in accordance with a user action performed at a user interface of said graphical interface layer.
